(19) United States
(12) Patent Application Publication
(10) Pub. No.: US 2019/0108922 A1
(43) Pub. Date: Apr. 11, 2019

(54) REMOVABLE MANDREL FOR AUTOMATING PROCESS TO MANUFACTURE CERAMIC COMPOSITE NUCLEAR FUEL CLADDING TUBES

(71) Applicant: WESTINGHOUSE ELECTRIC COMPANY, LLC, Cranberry Township, PA (US)

(72) Inventor: EDWARD J. LAHODA, EDGEWOOD, PA (US)

(73) Assignee: WESTINGHOUSE ELECTRIC COMPANY, LLC, Cranberry Township, PA (US)

(21) Appl. No.: 15/726,737

(22) Filed: Oct. 6, 2017

(51) Int. Cl. G21C 21/00; C04B 35/80; C04B 35/628; C04B 35/64; G21C 3/20

(52) U.S. Cl. CPC G21C 21/00; C04B 35/803; C04B 35/806; C04B 35/62844; C04B 35/64; G21C 3/20; G21Y 2004/40; C04B 2235/3826; C04B 2235/483; C04B 2235/5224; C04B 2235/3217; C04B 2235/6028; C04B 2235/5244

(57) ABSTRACT

The method described herein uses a ceramic precursors and controlled temperature rises for forming a stiffened ceramic composite fiber matrix to form a ceramic composite fuel cladding tube of the desired geometry and for removing a mandrel about which the composite fiber matrix was formed. The method described herein allows the manufacture of elongated ceramic composite claddings where the mandrel used to define the geometry of the cladding is easily removed without damaging the ceramic composite cladding. The method includes covering ceramic fibers with a mixture comprising at least one precursor of a ceramic material, wrapping the precursor covered fibers around a mandrel, heating the precursor covered fibers to the decomposition temperature of the precursor to convert the precursor to the ceramic material, and heating the mandrel to at least the melting point thereof to remove the mandrel.

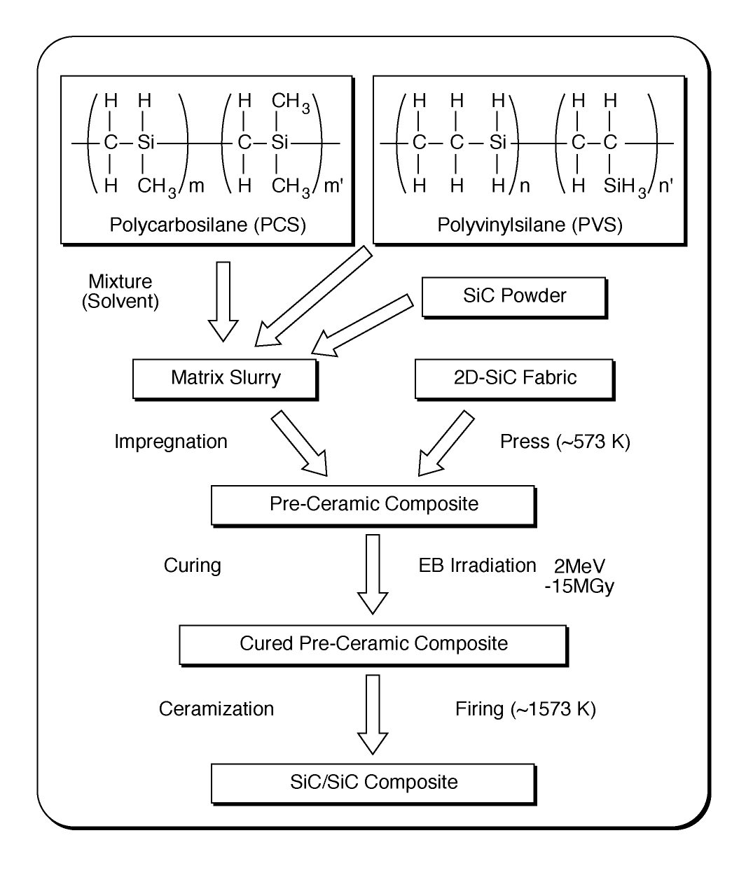

### STATEMENT REGARDING GOVERNMENT RIGHTS

This invention was made with government support under Contract No. DE-NE0008222 awarded by the Department of Energy. The U.S. Government has certain rights in this invention.

### BACKGROUND OF THE INVENTION

### 1. Field of the Invention

The invention relates to nuclear fuel rod cladding, and more particularly to methods for making ceramic composite fuel rod claddings.

### 2. Description of the Prior Art

Ceramic type materials, such as silicon carbide (SiC) and aluminum (III) oxide (Al₂O₃) monoliths and fibers, are described in U.S. Pat. Nos. 6,246,740, 5,391,428, 5,338,576; and 5,182,077 and U.S. Patent Publications Nos. 2006/0039524 A1 and 2007/0189952 A1. See also U.S. Pat. No. 9,455,053.

Ceramic composite materials have been proposed for use as claddings for nuclear fuel rods. The fuel rod claddings are currently made in a batch process that includes winding or braiding ceramic fibers, such as SiC or Al₂O₃, around a mandrel, then infiltrating the fibers and voids between fibers with the ceramic material under lower temperature conditions with a chemical vapor infiltration (CVI) process. An outer layer or barrier coating is then added using a chemical vapor deposition (CVD) process carried out at a higher temperature.

At the end of the process, the mandrel must be removed. This stage of the method can be particularly difficult because of the incidents of undesired bonding between the mandrel and the ceramic material. The cladding tube can be damaged during removal of the mandrel, requiring the damaged cladding tubes to be discarded, thereby raising the overall costs of production of the claddings. This is especially difficult for large aspect ratio structures such as nuclear fuel tubes which can range from 4 to 5 meters long and have a small diameter of less than 11 mm.

### SUMMARY OF THE INVENTION

An improved method of making ceramic composite fuel cladding tubes is provided herein. The improved method includes covering fibers made of a ceramic material with a mixture comprising at least one precursor of the ceramic material, wrapping the precursor covered fibers around a mandrel, the mandrel being made of a material having a melting point higher than a decomposition temperature at which the precursor converts to the ceramic material, heating the precursor covered fibers to the decomposition temperature of the precursor to convert the precursor to the ceramic material, and, heating the mandrel to at least the melting point thereof.

The mixture further comprises the ceramic material in powder or particulate form and a carrier, which in certain aspects, can be the ceramic precursor.

The method may further include heating the ceramic covered fibers to a crystallization temperature of the ceramic material to crystallize any amorphous ceramic material.

Covering the ceramic fibers with the mixture may in various aspects, include an application process selected from one or more of the group consisting of rolling the mixture over the fibers, immersing the fibers in a bath of the mixture, spaying the mixture onto the fibers and pulling the fibers through a bath of the mixture.

The ceramic material may be SiC or Al₂O₃, and the ceramic fibers may be SiC or Al₂O₃ fibers. Precursor of SiC may be selected from the group consisting of chloromethyl(triethoxy)silane, polycarbosilane, polyvinylsilane, polysilastyrene, and combinations thereof. A precursor of Al₂O₃ may be trimethylaluminum.

The mandrel may, in various aspects, be selected from the group consisting of cellulosic materials, metals and metal alloys.

In various aspects, there is also described a mandrel for use in forming a ceramic enclosure. The mandrel may comprise an elongate three dimensional structure made of a material having a melting point greater than the decomposition temperature of a ceramic precursor and less than the melting or decomposition point of a ceramic product formed on the mandrel. The mandrel may be made of a material selected from the group consisting of cellulosic materials, metals and metal alloys. The cellulosic materials may be paper or cardboard. The metals may be aluminum or copper and the alloys thereof. The melting point for these mandrel materials is preferably between 200° C. to 1600° C.

### BRIEF DESCRIPTION OF THE DRAWINGS

The characteristics and advantages of the present disclosure may be better understood by reference to the accompanying figure, which shows a schematic flow diagram of an exemplary process for producing SiC composite claddings using the polymer impregnation pyrolysis (PIP) method.

### DESCRIPTION OF THE PREFERRED EMBODIMENTS

As used herein, the singular form of “a”, “an”, and “the” include the plural references unless the context clearly dictates otherwise. Thus, the articles “a” and “an” are used herein to refer to one or to more than one (i.e., to at least one) of the grammatical object of the article. By way of example, “an element” means one element or more than one element.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Further, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

A “Ceramic Composite” as used herein may include materials such as SiC or Al₂O₃.

Ceramic composites are most preferably comprised of multiple layers of ceramic materials, including for example, dense monolithic SiC, or SiC—SiC composite, or a combination thereof. Additional layers may be added to provide additional features such as increased corrosion resistance, decreased pressure drop, increased heat transfer or other attributes.

As used herein, melting point means the point at which, or the temperature range within which, the material used for the referenced mandrel melts or combusts, depending on the chosen material. The terms are not intended to mean the theoretical value, but the more practical value where the material changes from the solid phase. As used with certain cellulosic materials, the melting point may be stated as an ignition or combustion point or range to more accurately describe the physical change to the material. In each case, it is the temperature or range thereof at which the material changes from a solid state to another state. Melting point may be a range of points of temperature within which, or the point at which, the first detectable liquid phase is detected or the temperature at which no solid phase is apparent. Factors influencing this phase transition include the size of the object, such as a mandrel, or particle sizes, the efficiency of heat diffusion, and the rate of heating. For some materials, the melting process may be accompanied by simultaneous decomposition or combustion.

The decomposition temperature of a material, as used herein, means the temperature or range of temperatures where there is extensive chemical species change caused by heat. For example, the temperature or range thereof where the ceramic precursor decomposes to the ceramic product and other reaction products.

In certain aspects of the improved method for making fuel claddings, ceramic fibers, such as SiC fibers with or without interface coatings, are covered or coated with ceramic precursors. Covering may be achieved by immersing the fibers in a mixture containing the ceramic precursors. In various aspects, covering may be achieved by dipping the ceramic fibers into a bath of ceramic precursors. In various aspects, covering may be achieved by pulling the ceramic fibers through a bath of ceramic precursors.

In various aspects, covering the fibers may be achieved by spraying a mixture comprised of ceramic precursors onto the fibers using, for example, a recirculating spray. In various aspects, covering may be achieved by rolling the mixture containing the ceramic precursors onto the fibers using, for example, rollers that have been immersed in the mixture containing the ceramic precursor. Those skilled in the art will appreciate that the fibers may be covered with the ceramic precursor in any of a number of ways.

The ceramic precursors may include any precursor of the ceramic material of choice, such as SiC or Al₂O₃, known to those skilled in the art that may be used in the PIP method, provided the desired ceramic material, i.e., SiC or Al₂O₃, is produced by the process. Exemplary SiC precursors include one of, or a combination of two or more of, chloromethyl(triethoxy)silane (CH₃CH₂O)₃—Si—CH₂Cl), polycarbosilane (—(R)Si—C—)n (wherein R is an alkyl group), polyvinylsilane (CH₃—Si[(CH₂═CH) (CH₃)Si]n-Si—CH₃), and polysilastyrene ([Si(C₆H₅) (CH₃)-]n₁-[Si(CH₃)₂]n₂-), etc., wherein n, n₁, and n₂ are integers, which may be the same or different, indicating the number of repeating units of the associated monomer. An exemplary Al₂O₃ precursor may be, but is not limited to, trimethylaluminum.

In various aspects, the ceramic precursor mixture may further include solid particles of the desired ceramic material in powder or particulate form. The mixture may include a carrier. Exemplary carriers include benzene, xylene or other solvents that do not react with the precursor materials. In various aspects, the ceramic precursors may act as the carrier, without use of a solvent as a carrier.

After being covered in the ceramic precursors, the ceramic fibers are wound or braided or otherwise wrapped around a three dimensional, elongated mandrel having the same geometric shape as the desired geometric shape of the finished cladding. Exemplary shapes include rods, tubes, and columns, e.g., elongate structures being circular, oval, rectangular, square, or triangular in cross-section. Other shapes may be used as long as the mandrel provides a stable structure for forming a stiffened, mechanically stable ceramic composite cladding.

The mandrel is made of a material having a melting point greater than the decomposition point of the ceramic precursor and less than the decomposition or melting point of the finished ceramic composite cladding. Exemplary mandrel materials include cellulosic materials (excluding plastics), such as paper and cardboard which have an ignition or combustion point of about 258° C., and metals, such as aluminum and copper, and metal alloys, such as aluminum alloys and copper alloys. Aluminum has a melting point of about 660° C. Aluminum alloys suitable for the method of making composite ceramic claddings have a melting point ranging from 500° C. to 800° C. Copper has a melting point of about 1083° C. Copper alloys suitable for the method of making composite ceramic claddings have a melting point ranging from 600° C. to 1100° C. Other exemplary mandrel materials include magnesium and its alloys.

The SiC fiber may preferably be a SiC fiber containing primarily Si and C, and some trace or relatively small amounts of 0. Exemplary amounts may include
Si: 50% to 70% (more preferably 60% to 70%)
C: 30% to 40% (more preferably 30% to 38%)
O: 0.01% to 14% (more preferably 0.01% to 1%)

The ceramic yarn that is wound around the mandrel is formed from small ceramic fibers that are wound into a tow to make the yarn. The yarn is formed into the desired geometry using conventional techniques known in the art including, for example, braiding, knitting, weaving, or winding the yarn around a workpiece, referred to herein as a mandrel. See, for example, U.S. Pat. No. 5,391,428. The contours of the wrapped fiber yarn creates uneven surfaces and voids or interstices between and among adjacent sections of yarn.

As the ceramic fibers are wrapped around the mandrel, the wrapping process presses the precursor mixture (with or without ceramic material solids) into the interstices in and around the uneven surface contours of the ceramic fiber wrapping. Any excess mixture covering the fibers may be squeezed out and fall away.

After the fibers covered in the ceramic precursor mixture are wrapped around the mandrel, sufficient heat is applied to decompose the ceramic precursor to form the ceramic material (e.g., SiC or Al₂O₃). At and around this decomposition temperature, the precursor is converted to the ceramic material and due at least in part to the pressure applied during wrapping as well as the decomposition process itself, the ceramic material at least partially fills the voids in the fiber wrappings. The decomposition temperature may be held for a time sufficient to convert enough of the ceramic precursor to the ceramic material to a point that the ceramic fiber structure covered with ceramic material is mechanically stable, forming a stiffened fiber structure that will not change geometry during subsequent processing steps. The carrier or any solvents or other reaction products in the mixture are diffused out or gassed off or otherwise removed during the heating step by known techniques appropriate to the non-ceramic material products and mixture components to be removed.

Chloromethyl(triethoxy)silane, for example begins to decompose at 220° C., and in this aspect, the decomposition temperature will be about 220° C. Polycarbosilane begins to decompose at 150° C. to 250° C. and polyvinylsilane begins to decompose at about 220° C. The decomposition temperatures of other ceramic precursors, and specifically, other SiC or Al₂O₃ precursors, can be readily determined from the literature or by routine testing by those skilled in the art.

Various ways of heating may be used, depending on the material used for the mandrel. For example, the heat may be applied with electron beam irradiation, for example, at 2 MeV or 15 mGy for any of the paper, cardboard, metal, or metal alloy forms of the mandrel. The heat may alternatively be applied by induction or microwave heating. More conventional heating in a furnace may also be a source of the heat used to reach the decomposition temperature and subsequent temperature changes to carry out the method described herein where the mandrel is made of a metal or a metal alloy. The source and method of heating to decompose the precursor to form the ceramic material should not at this stage, melt or combust the mandrel.

When the SiC composite structure is sufficiently stiffened, the temperature of the mandrel may, in various aspects, be raised further to the melting point of the mandrel. In order to remove the mandrel without damaging the stiffened ceramic fiber structure, the mandrel temperature is raised to its melting point, higher than the precursor decomposition temperature, sufficient to melt or decompose the mandrel itself, leaving an intact stiffened ceramic fiber structure.

The mandrel melting point temperature will vary depending on the material with which the mandrel is made. The mandrel melting point temperature may be in the range of about 200° C. to 1600° C., and in certain aspects may be in the range of 500° C. to 1200° C., or in certain aspects, may be in the range of 500° C. to 1000° C. In certain aspects, the mandrel melting point temperature may be in the range of about 350° C. to 800° C. For example, if the mandrel is made of a cellulosic material such as paper or cardboard, the mandrel melting point, more accurately referred to as the combustion temperature for this mandrel material, will be about 258° C. In those embodiments where the mandrel is made of aluminum, the mandrel melting point temperature will be about 660° C., but for an aluminum alloy, the mandrel melting point temperature will be vary widely, depending on the fluctuations in the melting point attributable to the other elements of the alloy. Some know aluminum alloys have melting points that range from about 382° C. to 800° C. In those embodiments where the mandrel is made of copper, the mandrel melting point temperature will be about 1084° C., and if a copper alloy, the mandrel melting point temperature will vary depending on the fluctuations in the melting point attributable to the other elements of the alloy. For example, the mandrel melting point temperature may be about 548° C. to 955° C.

The ceramic fiber structure may, in various aspects, have amorphous ceramic materials covering the fibers and filling the voids within the fiber matrix. To convert any amorphous ceramic material to a crystalline state, the temperature is raised to the crystallization temperature of the ceramic material used to cover the fibers. The crystallization temperature for SiC, for example is about 1300° C. Crystallization converts the SiC from the amorphouse to beta-phase SiC. Al₂O₃ occurs naturally primarily in its crystalline form. When converted from its precursor to Al₂O₃, the crystallization temperature for Al₂O₃ is about 1000° C.

After crystallization, the ceramic composite fuel rod cladding formed to a desired three dimensional geometry, free of the mandrel used to define the cladding geometry during its formation, and free of damage that may be caused by conventional methods of removing the mandrel, may be further coated using, for example a CVD or other suitable known process to deposit a protective barrier layer, such as a water resistant or corrosion barrier layer.

The method described herein uses a ceramic precursors and controlled temperature rises for both forming the stiffened ceramic fibers and ceramic coverings to form a ceramic composite fuel cladding tube of the desired geometry and removing the mandrel about which the cladding was formed. The method described herein allows the manufacture of elongated ceramic composite claddings where the mandrel used to define the geometry of the cladding is easily removed without damaging the ceramic composite cladding. In certain aspects, when the ceramic product is SiC, the process produces a ceramic composite material that is between 70% and 80% of the theoretical density of SiC.

All patents, patent applications, publications, or other disclosure material mentioned herein, are hereby incorporated by reference in their entirety, except that all references, and any material, or portion thereof, that are said to be incorporated by reference herein are incorporated herein only to the extent that the incorporated material does not conflict with existing definitions, statements, or other disclosure material expressly set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative embodiments. The embodiments described herein are understood as providing illustrative features of varying detail of various embodiments of the disclosed invention; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed invention. Accordingly, it will be recognized by persons having ordinary skill in the art that various substitutions, modifications or combinations of any of the exemplary embodiments may be made without departing from the scope of the invention. In addition, persons skilled in the art will recognize, or be able to ascertain using no more than routine experimentation, many equivalents to the various embodiments of the invention described herein upon review of this specification. Thus, the invention is not limited by the description of the various embodiments, but rather by the claims.

What is claimed is:

1. A method for making a cladding for a nuclear fuel rod comprising:
covering fibers made of a ceramic material with a mixture comprising at least one precursor of the ceramic material;
wrapping the precursor covered fibers around a mandrel, the mandrel being made of a material having a melting point higher than a decomposition temperature at which the precursor converts to the ceramic material;
heating the precursor covered fibers to the decomposition temperature of the precursor to convert the precursor to the ceramic material; and,
heating the mandrel to at least the melting point thereof.

2. The method recited in claim 1 further comprising:
heating the ceramic covered fibers to a crystallization temperature of the ceramic material to crystallize any amorphous ceramic material.

3. The method recited in claim 1 wherein:
covering the ceramic fibers with the mixture comprises an application process selected from one or more of the group consisting of rolling the mixture over the fibers, immersing the fibers in a bath of the mixture, spaying the mixture onto the fibers and pulling the fibers through a bath of the mixture.

4. The method recited in claim 1 wherein the mixture further comprises the ceramic material in powder or particulate form and a carrier.

5. The method recited in claim 1 wherein:
the ceramic fibers are SiC fibers.

6. The method recited in claim 5 wherein:
the ceramic material is SiC.

7. The method recited in claim 6 wherein:
the precursor of the ceramic material is selected from the group consisting of chloromethyl(triethoxy)silane, polycarbosilane, polyvinylsilane, polysilastyrene, and combinations thereof.

8. The method recited in claim 1 wherein:
the ceramic fibers are Al₂O₃ fibers.

9. The method recited in claim 8 wherein:
the ceramic material is Al₂O₃.

10. The method recited in claim 9 wherein:
the precursor of the ceramic material is trimethylaluminum.

11. The method recited in claim 1 wherein:
the decomposition temperature falls within a range of 200° C. to 1600° C.

12. The method recited in claim 1 wherein:
the decomposition temperature falls within a range of 500° C. to 1200° C.

13. The method recited in claim 1 wherein:
the mandrel is selected from the group consisting of cellulosic materials, metals and metal alloys.

14. The method recited in claim 13 wherein:
the mandrel material is selected from the group consisting of paper and cardboard, and the melting point of the mandrel material is a combustion point of about 258° C.

15. The method recited in claim 1 wherein:
the mandrel material is selected from the group consisting of metals and metal alloys, and the melting point of the mandrel material is within the range of about 200° C. to 1083° C.

16. The method recited in claim 15 wherein the metals are selected from the group consisting of aluminum and copper.

17. The method recited in claim 15 wherein the metal alloys are selected from the group consisting of aluminum alloys and copper alloys.

18. A mandrel for use in forming a ceramic enclosure comprising:
an elongate three dimensional structure made of a material having melting point greater than the decomposition temperature of a ceramic precursor and less than the melting point of a ceramic product formed on the mandrel.

19. The mandrel recited in claim 18 wherein the melting point is between 200° C. to 1600° C.

20. The mandrel recited in claim 18 wherein the mandrel material is selected from the group consisting of cellulosic materials, metals and metal alloys.

21. The mandrel recited in claim 18 wherein the mandrel material is a metal alloy selected from the group consisting of aluminum alloys and copper alloys.

22. The mandrel recited in claim 18 wherein the mandrel material is a cellulosic material selected from the group consisting of paper and cardboard, and the melting point of the mandrel material is a combustion point of about 258° C.

23. The mandrel recited in claim 18 wherein the ceramic precursor is selected from the group consisting of chloromethyl(triethoxy)silane, polycarbosilane, polyvinylsilane, polysilastyrene, and combinations thereof.

24. The mandrel recited in claim 23 wherein the ceramic product is SiC.

25. The mandrel recited in claim 18 wherein the ceramic product is Al₂O₃.
